(19) United States
(12) Patent Application Publication
(10) Pub. No.: US 2026/0126924 A1
(43) Pub. Date: May 7, 2026

(54) COMPLETE AND INCOMPLETE SUPERBLOCK GENERATION

(71) Applicant: Micron Technology, Inc., Boise, ID (US)

(72) Inventors: Mingyi Li, Shanghai (CN); Xiaolai Zhu, Shanghai (CN); Xing Wang, Shanghai (CN); Xiangang Luo, Fremont, CA (US)

(21) Appl. No.: 18/702,738

(22) PCT Filed: Mar. 14, 2023
(86) PCT No.: PCT/CN2023/081274

§ 371 Date: Apr. 18, 2024

(51) Int. Cl. G06F 3/06

(52) U.S. Cl. CPC G06F 3/064; G06F 3/0608; G06F 3/0673

(57) ABSTRACT

Methods, systems, and devices for complete and incomplete superblock generation are described. A memory system may be configured to generate and access complete and incomplete superblocks by replacing invalid physical blocks with valid physical blocks from a same plane. For example, he memory system may perform a scan to determine (e.g., identify) which blocks are valid, invalid, or both. The memory system may replace invalid blocks from superblocks having a relatively small quantity of invalid blocks with blocks (e.g., blocks from a same plane) from superblocks having a relatively large quantity of invalid blocks, which may result in the generation of complete and incomplete superblocks.

### CROSS REFERENCE

The present Application for Patent is a 371 national phase filing of International Patent Application No. PCT/CN2023/081274 by Li et al., entitled “COMPLETE AND INCOMPLETE SUPERBLOCK GENERATION,” filed Mar. 14, 2023, assigned to the assignee hereof, and expressly incorporated by reference in its entirety herein.

### TECHNICAL FIELD

The following relates to one or more systems for memory, including complete and incomplete superblock generation.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 illustrates an example of a system that supports complete and incomplete superblock generation in accordance with examples as disclosed herein.

FIG. 2 illustrates an example of a block diagram that supports complete and incomplete superblock generation in accordance with examples as disclosed herein.

FIG. 3 illustrates an example of a process flow that supports complete and incomplete superblock generation in accordance with examples as disclosed herein.

FIG. 4 illustrates an example of a process flow that supports complete and incomplete superblock generation in accordance with examples as disclosed herein.

FIG. 5 illustrates an example of a process flow that supports complete and incomplete superblock generation in accordance with examples as disclosed herein.

FIG. 6 illustrates a block diagram of a memory system that supports complete and incomplete superblock generation in accordance with examples as disclosed herein.

FIG. 7 illustrates a flowchart showing a method or methods that support complete and incomplete superblock generation in accordance with examples as disclosed herein.

### DETAILED DESCRIPTION

A memory system may support the use of superblocks, which include blocks (e.g., a set of blocks) from a contiguous set of planes (e.g., each plane) of the memory system. In some cases, the memory system may perform access operations on the blocks of the superblock. In some instances, however, the memory system may be unable to perform one or more access operations on the superblock if one or more blocks of the set of blocks associated with the superblock are invalid (e.g., bad, corrupt, otherwise inaccessible). In some such cases, the memory system may attempt to replace the one or more invalid blocks with one or more valid blocks from a replacement pool of blocks. However, such pools of replacement blocks may increase overprovisioning associated with the memory device, which may increase the memory device's overall size. Moreover, such pools of replacement blocks may be relatively ineffective in replacing invalid blocks, which may decrease the usable storage capacity of the memory system. Accordingly, a memory system configured to generate complete and incomplete, usable superblocks may be desirable.

In accordance with examples as described herein, a memory system may be configured to generate and access complete superblocks (e.g., superblocks that do not include invalid blocks) and incomplete superblocks (e.g., superblocks that each include a singular invalid block). For example, the memory system may scan one or more physical blocks associated with one or more superblocks to determine which physical blocks are invalid and/or valid. The superblocks may then be assigned to slots, where each slot may include one or more superblocks each with a respective quantity of invalid blocks (e.g., slot 0 includes superblocks with 0 invalid blocks, slot 1 includes superblocks 1 with 1 invalid block).

The memory system may, in some examples, perform a block replacement on a superblock having 1 invalid block, which may result in the creation of a complete superblock. To replace the invalid block, the memory system may determine whether a second superblock from a different slot (e.g., slot 15) includes a valid block in the same plane as the invalid block. If the second superblock includes a valid block in the same plane, the invalid block may be replaced by the valid block of the second superblock. If the second superblock does not include a valid block in the same plane as the invalid block, the memory system may continue determining whether superblocks from relatively higher slots (e.g., slot 14, slot 13) include a valid block in the same plane.

The memory system may continue performing such operations to create complete superblocks (e.g., superblocks having no invalid blocks) and incomplete superblocks (e.g., superblocks having at least one invalid block). Both the complete superblocks and the incomplete superblocks may be accessible (e.g., by a host system), despite the incomplete superblocks having at least one bad block. Accordingly, the methods described herein to generate complete and incomplete superblocks may reduce overprovisioning associated with the memory system, which may reduce its overall size. Moreover, accessing incomplete superblocks may increase or otherwise prolong the usable storage capacity of the memory system, among other advantages.

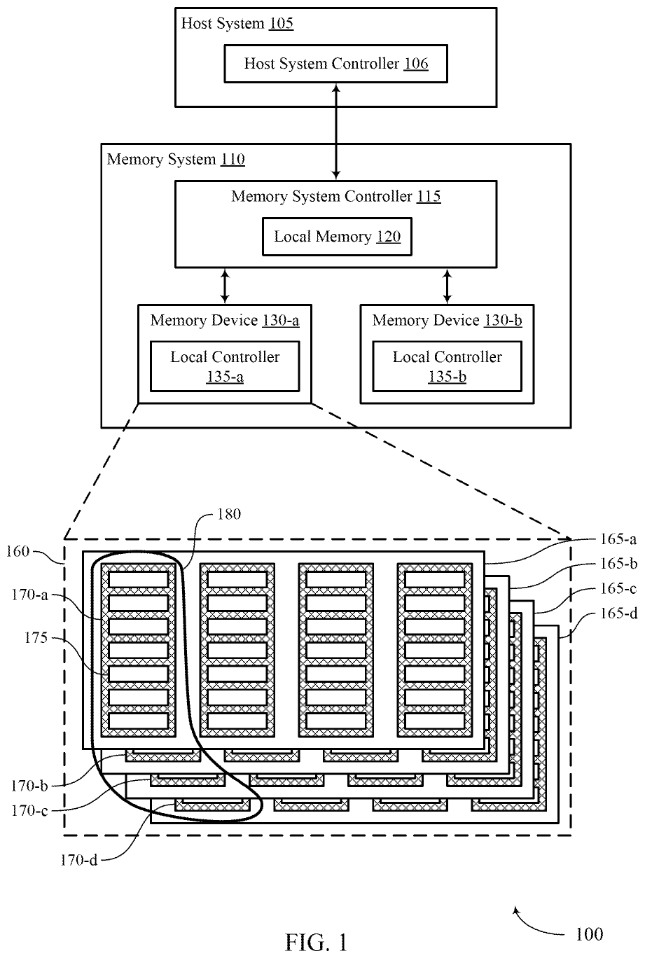

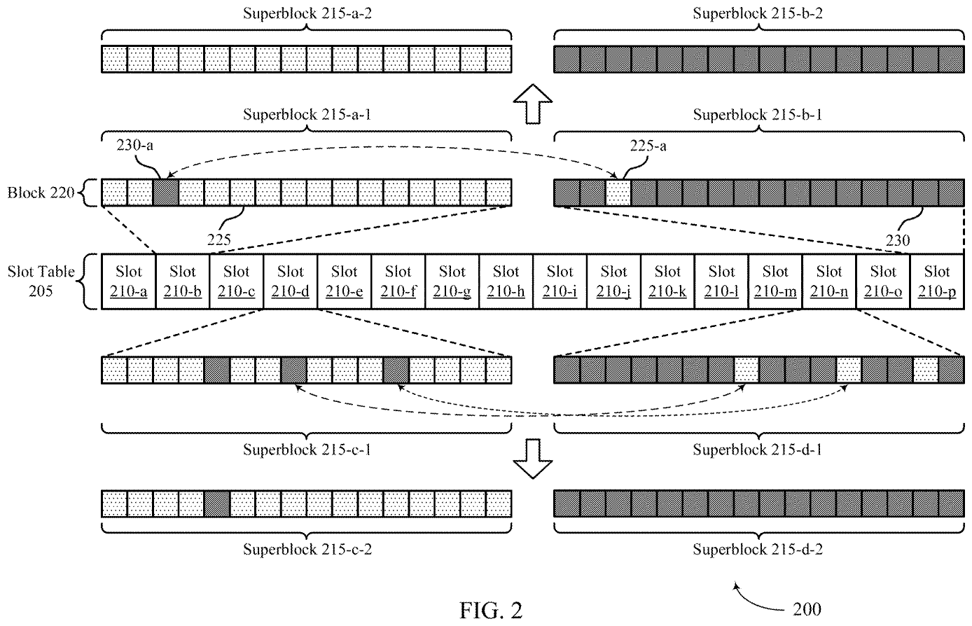

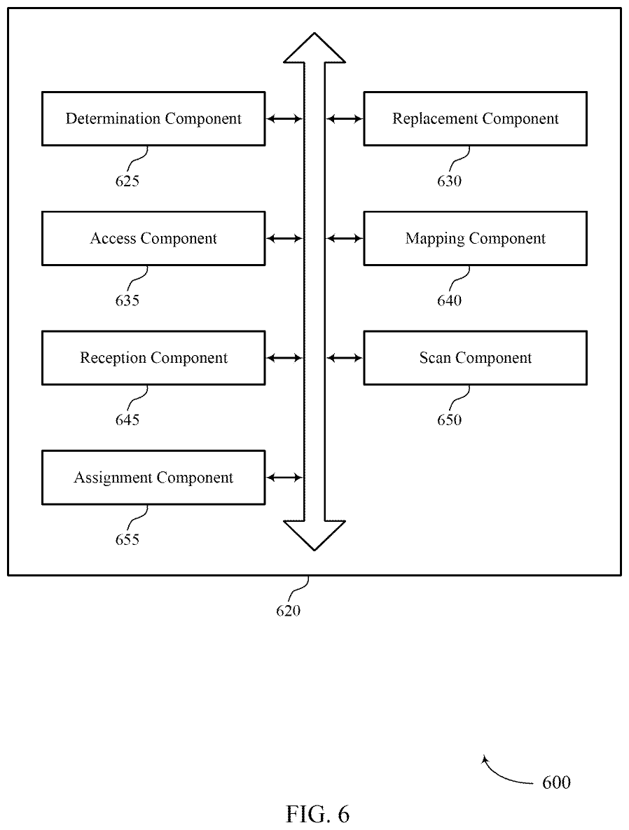

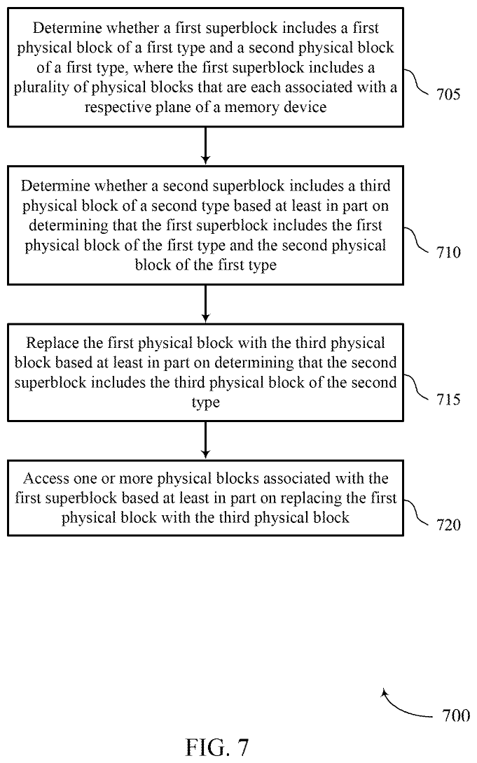

Features of the disclosure are initially described in the context of a system with reference to FIG. 1. Features of the disclosure are described in the context of a block diagram and process flows with reference to FIGS. 2 through 5. These and other features of the disclosure are further illustrated by and described in the context of an apparatus diagram and flowchart that relate to complete and incomplete superblock generation with reference to FIGS. 6 and 7.

FIG. 1 illustrates an example of a system 100 that supports complete and incomplete superblock generation in accordance with examples as disclosed herein. The system 100 includes a host system 105 coupled with a memory system 110. The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180 (e.g., or a superblock when the blocks 170 are from each of the contiguous planes 165). In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

The system 100 may include any quantity of non-transitory computer readable media that support complete and incomplete superblock generation. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In accordance with examples as described herein, the memory system 110 may be configured to generate and access complete superblocks (e.g., superblocks that do not include invalid blocks) and incomplete superblocks (e.g., superblocks that each include a singular invalid block). For example, the memory system controller 115 may scan the physical blocks (e.g., of the memory device 130) associated with one or more superblocks to determine which physical blocks are invalid. The superblocks may then be assigned to slots, where each slot may include superblocks each with a respective quantity of invalid blocks (e.g., slot 0 includes superblocks with 0 invalid blocks, slot 1 includes superblocks 1 with 1 invalid block, etc.).

The memory system controller 115 may perform a block replacement on a superblock having 1 invalid block, which may result in the creation of a complete superblock. To replace the invalid block, the memory system controller 115 may determine whether a second superblock from a different slot (e.g., slot 15) includes a valid block in the same plane as the invalid block. If the second superblock includes a valid block in the same plane, the invalid block may be replaced by the valid block of the second superblock. If the second superblock does not include a valid block in the same plane as the invalid block, the memory system may continue determining whether superblocks from relatively higher slots (e.g., slot 14, slot 13, etc.) include a valid block in the same plane.

The memory system controller 115 may continue performing such operations to create complete superblocks (e.g., superblocks having no invalid blocks) and incomplete superblocks (e.g., superblocks having one invalid block). Both the complete superblocks and the incomplete superblocks may be accessible (e.g., by a host system), despite the incomplete superblocks having one bad block. Accordingly, the methods described herein to generate complete and incomplete superblocks may reduce overprovisioning associated with the memory system 110, which may reduce its overall size. Moreover, accessing incomplete superblocks may increase or otherwise prolong the usable storage capacity of the memory system 110.

In addition to applicability in memory systems as described herein, techniques for complete and incomplete superblock generation may be generally implemented to improve the performance (including gaming) of various electronic devices and systems. Some electronic device applications, including gaming and other high-performance applications, may be associated with relatively high processing requirements while also benefitting from relatively quick response times to improve user experience. As such, increasing processing speed, decreasing response times, or otherwise improving the performance electronic devices may be desirable. Implementing the techniques described herein may improve the performance of electronic devices by enabling the electronic devices to generate and access complete and incomplete superblocks, which may increase a total usable storage capacity of the electronic devices, among other benefits.

FIG. 2 illustrates an example of a block diagram 200 that supports complete and incomplete superblock generation in accordance with examples as disclosed herein. The block diagram 200 may illustrate aspects or operations of a system 100, as described with reference to FIG. 1. For example, operations illustrated by the block diagram 200 may be performed by a memory system 110 (e.g., a memory system controller 115) or a host system 105. The block diagram 200 may depict generating a complete superblock and an incomplete superblock by replacing invalid blocks of superblocks with valid superblocks from a same plane. Such methods may reduce overprovisioning associated with the memory system, which may reduce its overall size. Moreover, accessing incomplete superblocks may increase or otherwise prolong the usable storage capacity of the memory system.

A memory system controller may utilize a slot table 205 for managing a set of slots 210. The slot table 205 may be a table or other logical structure that may be utilized to manage (e.g., track) valid and invalid blocks across superblocks 215. As described herein, each superblock 215 may include a set of blocks 220, which may be examples of a block 170, as described with reference to FIG. 1. Each superblock 215 may be associated with a set of physical blocks of the memory system from each plane of the memory system (e.g., 1 block from each plane) and may represent a logical (e.g., virtual) partitioning (e.g., grouping) of the set of physical blocks. Each superblock 215 may be an example of a virtual block 180 with a quantity of blocks 220 corresponding to a quantity of planes of the memory system, as described with reference to FIG. 1.

For example, each superblock 215 may include 16 blocks 220 (e.g., corresponding to 16 planes of the memory system), where each block 220 is associated with a plane of a memory system. In some cases, the memory system may include multiple memory devices such that each superblock 215 may include blocks 220 from each plane of the one or more memory devices (e.g., 4 memory devices with 4 planes each). In some implementations, the blocks 220 may be ordered within a respective superblock 215 based on an order of the planes of the memory system, such that contiguous blocks 220 may be associated with contiguous planes (e.g., a first block 220 may correspond to a first plane, a second block 220 may correspond to a second plane, etc.).

In some cases, the blocks 220 may be valid blocks 225 (e.g., a block including a quantity of valid data, a quantity of valid physical blocks, a quantity of operable access lines, or any combination thereof, that satisfies a threshold) or invalid blocks 230 (e.g., a block including a quantity of invalid data, a quantity of invalid physical blocks, a quantity of inoperable access lines, or any combination thereof, that satisfies a second threshold). In some cases, the invalid blocks 230 may be inaccessible when performing an access operation (e.g., a read operation, a write operation, a refresh operation, a media management operation, a wear leveling operation) or may otherwise result in one or more errors due to being accessed. In some instances, each superblock 215 may include a quantity of valid blocks 225, a quantity of invalid blocks 230, or both. For example, superblock 215-a-1 may include 15 valid blocks 225 and 1 invalid block 230 in a third plane, whereas superblock 215-c-1 may include 13 valid blocks 225 and 3 invalid blocks 230 in a fifth plane, an eighth plane, and a twelfth plane, respectively.

Each superblock 215 may be assigned to a respective slot 210 based on a quantity of invalid blocks 230 (e.g., or valid blocks 225) in the superblock 215. That is, the memory system may include N+1 slots 210, and each slot 210 may be associated with superblocks 215 having X invalid blocks 230, where X may be 0, 1, . . . N. For example, slot 210-a (e.g., slot 0) may include superblocks 215 having 0 invalid blocks 230, slot 210-b (e.g., slot 1) may include superblocks 215 having 1 invalid blocks 230, and slot 210-p (e.g., slot 15) may include superblocks 215 having 15 invalid blocks 230. In some such examples, the slot 210-a may be associated with storing complete superblocks (e.g., superblocks 215 having zero invalid blocks 230). In some instances, superblocks 215 having a quantity of invalid blocks 230 equal to the quantity of blocks 220 in the superblocks 215 (e.g., superblocks 215 having no valid blocks 225) may be assigned to a discard pool and may otherwise be inaccessible.

The block diagram 200 depicts generating a complete superblock (e.g., superblock 215-a-2), where a complete superblock may not include any invalid blocks 230. The memory system (e.g., or the host system) may generate a complete superblock by identifying a superblock 215 (e.g., superblock 215-a-1) having one or more invalid blocks 230, and by identifying one or more planes associated with the one or more invalid blocks 230. For example, the memory system may determine that a superblock 215-a-1 from slot 210-b includes an invalid block 230-a in the third plane of the memory system.

After identifying the superblock 215 with the one or more invalid blocks 230 and identifying the one or more planes associated with the one or more invalid blocks 230, the memory system may identify a second superblock 215 (e.g., superblock 215-b-1) having one or more valid blocks 225 in the one or more identified planes. In some cases, the memory system may identify the second superblock 215 based on scanning the slot 210 associated with the lowest quantity of valid blocks 225 (e.g., slot 210-p).

If the memory system determines that the slot 210 does not include any superblocks 215 with one or more valid blocks 225 in the one or more identified planes, the memory system may scan the slot 210 having the next lowest quantity of valid blocks 225 (e.g., slot 210-0). In some examples, this process of scanning and moving to the next slot may continue until a second superblock 215 having one or more valid blocks 225 in the one or more identified planes is identified. After identifying the second superblock 215 with one or more valid blocks 225 in the identified planes, the memory system may replace the one or more invalid blocks 230 with the one or more valid blocks 225. For example, the memory system may determine that a superblock 215-b-1 associated with the slot 210-p includes a valid block 225-a in the third plane, and the memory system may replace the invalid block 230-a in the superblock 215-a-1 with the valid block 225-a from the superblock 215-b-1. In some implementations, the memory system may utilize multiple superblocks 215 from one or more slots 210 replace one or more invalid blocks 230.

In some cases, replacing the one or more invalid blocks 230 of the superblock 215 may include updating a mapping of the superblock 215, such that the one or more valid blocks 225 from the second superblock 215 are mapped to the superblock 215. For example, the valid block 225-a may be mapped to the superblock 215-a-2, and the invalid block 230-a may be mapped to the superblock 215-b-2. In some implementations, updating the mapping may include updating an L2P table of the memory system.

After replacing the one or more invalid blocks 230 of the superblock 215, the memory system may reassign the superblock 215 and the second superblock 215 to respective slots 210 (e.g., or to the discard pool) based on the updated quantities of invalid blocks 230 in the superblocks 215. For example, after replacing the invalid block 230-a with the valid block 225-a, the superblock 215-a-1 may be a complete superblock 215-a-2 and may be reassigned to the slot 210-a. Additionally, or alternatively, the superblock 215-b-1 may be a discarded superblock 215-b-2, and may be reassigned to the discard pool.

The block diagram 200 also depicts generating an incomplete superblock (e.g., superblock 215-c-2), where an incomplete superblock may include one invalid block 230. The memory system (e.g., or the host system) may generate an incomplete superblock by identifying a superblock 215 with two or more invalid blocks 230 and by identifying two or more planes associated with the two or more invalid blocks 230. For example, the memory system may determine that a superblock 215-c-1 from slot 210-d includes 3 invalid blocks 230 in the fifth plane, eighth plane, and twelfth plane of the memory system, respectively.

After identifying the superblock 215 with the two or more invalid blocks 230 and identifying the two or more planes associated with the two or more invalid blocks 230, the memory system may identify a second superblock 215 with one or more valid blocks 225 in the two or more identified planes. In some cases, the memory system may identify the second superblock 215 based on scanning the slot 210 associated with the lowest quantity of valid blocks 225 (e.g., slot 210-p) in the superblocks 215. In some such cases, the memory system may determine that the slot 210 does not include any superblocks 215 with one or more valid blocks 225 in the two or more identified planes, and the memory system may scan the slot 210 with the next lowest quantity of valid blocks 225 (e.g., slot 210-o) in the superblocks 215.

In some examples, the process of scanning and moving to the next slot may continue until the second superblock 215 with one or more valid blocks 225 in the two or more identified planes is identified. After identifying the second superblock 215 with one or more valid blocks 225 in the identified planes, the memory system may replace at least one of the invalid blocks 230 with a valid blocks 225. For example, the memory system may identify a superblock 215-d-1 from the slot 210-n includes three valid blocks 225 in the eighth, twelfth, and fifteenth planes, respectively, and the memory system may replace the two corresponding invalid blocks 230 in the superblock 215 (e.g., the invalid blocks 230 in the eighth and twelfth planes) accordingly. In some implementations, the memory system may select valid blocks 225 from multiple superblocks 215 for block replacement. That is, different superblocks 215 may be used to replace respective invalid blocks 230 of the superblock 215-c-1.

In some cases, replacing one or more invalid blocks 230 of the superblock 215 may include updating a mapping of the superblock 215, such that the one or more valid blocks 225 from the second superblock 215 are mapped to the superblock 215. For example, the valid blocks 225 from the superblock 215-d-1 may be mapped to the superblock 215-c-2, and two of the invalid blocks 230 from the superblock 215-c-1 may be mapped to the superblock 215-d-2. In some implementations, updating the mapping may include updating an L2P table of the memory system (e.g., at non-volatile memory of the memory system), or a portion of the L2P table stored in volatile memory of the memory system.

After replacing one or more invalid blocks 230 of the superblock 215, the memory system may reassign the superblock 215 and the second superblock 215 to respective slots 210 (e.g., or to the discard pool) based on the updated quantities of invalid blocks 230 in the superblocks 215. For example, the superblock 215-c-1 may be updated to be an incomplete superblock 215-c-2 (e.g., a complete superblock) and may be reassigned to the slot 210-b. Additionally, or alternatively, the superblock 215-d-2 may be reassigned to the slot 210-p.

The memory system may access (e.g., read, write, erase, refresh, wear level) a complete superblock 215 in accordance with performing one or more access operations. In some instances, the memory system may modify one or more aspects of an access operation to access an incomplete superblock 215. For example, the memory system may be unable to access the invalid block 230 in the incomplete superblock 215. Therefore, the memory system may record an indication of a plane associated with the invalid block 230, and the memory system may use the indication to skip the plane during an access operation. For example, the memory system may receive an access command for an address of a superblock 215, and the memory system may determine whether the address is associated with an invalid block 230 or a valid block 225 of the superblock 215.

The memory system may access the address based on determining whether the address is associated with a valid block 225. In some cases, the memory system may determine whether the address is associated with a valid block 225 that is ordered (e.g., sequentially ordered) before an invalid block 230 in the superblock 215. In some cases, the memory system may determine the address is associated with a valid block 225 that is ordered before the invalid block 230, and the memory system may access the address (e.g., access the actual received address).

In other cases, the memory system may determine the address is associated with a valid block 225 that is ordered after an invalid block 230 in the superblock 215 and the memory system may adjust the address to account for skipping the invalid block 230 in the order. For example, the memory system may access the address in another plane (e.g., a subsequent plane, associated with a valid block 225) of the superblock 215 by incrementing the received address by one (e.g., received plane address +1). In other cases, the memory system may determine that the address is associated with the invalid block 230 of the superblock 215, and the memory system may adjust the address to account for skipping the invalid block 230 in the order by accessing the address in another plane (e.g., a subsequent plane, associated with a valid block 225) of the superblock 215. In some cases, the address received in the access command may be a virtual address and the memory system may access the L2P to determine the physical address. In some such cases, the memory system may use the physical address when determining whether the address is in a valid block 225 (e.g., before or after the invalid block in the order), or an invalid block 230.

In accordance with examples as described herein, the memory system may support generating and accessing both complete and incomplete superblocks 215. By supporting accessing the incomplete superblocks 215, the memory system may access superblocks 215 that may have otherwise been inaccessible. Such methods may reduce overprovisioning associated with the memory system, which may reduce its overall size. Moreover, accessing incomplete superblocks may increase or otherwise prolong the usable storage capacity of the memory system.

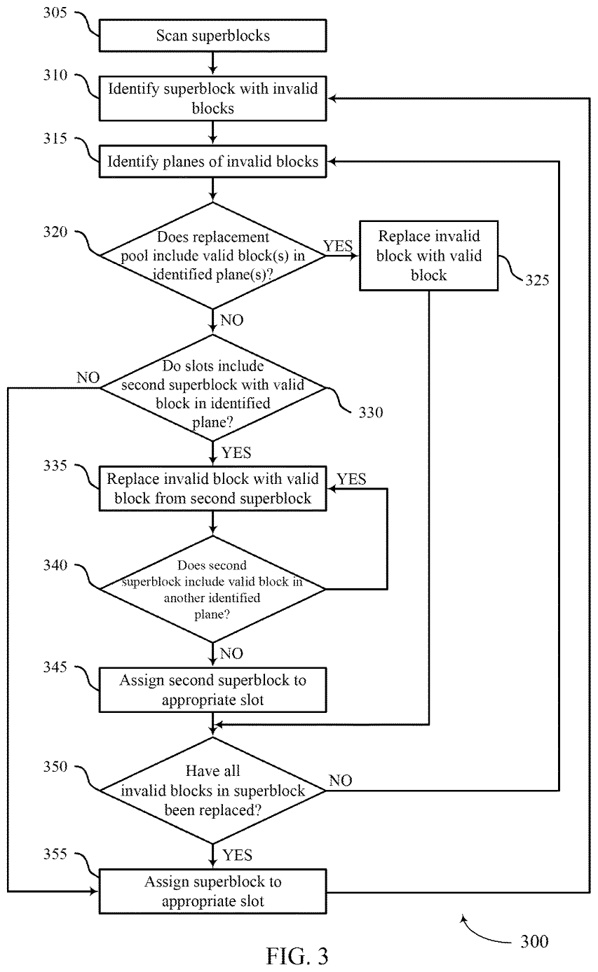

FIG. 3 illustrates an example of a process flow 300 that supports complete and incomplete superblock generation in accordance with examples as disclosed herein. The process flow 300 may illustrate aspects or operations of a system 100 and a block diagram 200, as described with reference to FIGS. 1 and 2, respectively. For example, the process flow 300 may depict operations for generating complete superblocks and incomplete superblocks, which may be examples of a superblock 215-a-2 and a superblock 215-c-2, respectively. Such methods may reduce overprovisioning associated with the memory system, which may reduce its overall size. Moreover, accessing incomplete superblocks may increase or otherwise prolong the usable storage capacity of the memory system.

In the following description of the process flow 300, the methods, techniques, processes, and operations may be performed in different orders or at different times. Further, certain operations may be left out of the process flow 300, or other operations may be added to the process flow 300. The process flow 300 illustrates operations for replacing invalid blocks of a memory system using a replacement pool or using complete and incomplete superblock generation techniques as described with reference to FIG. 2.

At 305, the memory system (e.g., or a host system coupled with the memory system) may scan superblocks of the memory system, which may be examples of superblocks 215 as described with reference to FIG. 2. The memory system may scan the superblocks to determine a quantity of invalid blocks and valid blocks in each superblock, which may be examples of invalid blocks 230 and valid blocks 225, as described with reference to FIG. 2.

In some examples, the memory system may assign the superblocks to slots, which may be examples of slots 210, as described with reference to FIG. 2, based on determining the quantity of invalid blocks and invalid blocks in each superblock. In some such examples, scanning the superblocks may include generating a slot table, which may be an example of a slot table 205, as described with reference to FIG. 2. In some cases, the memory system may scan the superblocks in response to an initiation procedure (e.g., powering on the memory system), or loading firmware onto the memory system.

At 310, the memory system may identify a superblock with one or more invalid blocks. In some cases, identifying the superblock may include identifying a slot associated with the superblock.

At 315, the memory system may identify one or more planes corresponding to the one or more invalid blocks.

At 320, the memory system may determine whether the replacement pool includes at least one valid block in at least one of the one or more identified planes. In some cases, the memory system may determine that the replacement pool includes at least one valid block in at least one of the one or more identified planes, and the process flow 300 may continue to step 325. In other cases, the memory system may determine that the replacement pool does not include a valid block in at least one of the one or more identified planes, and the process flow 300 may continue to step 330.

At 325, the memory system may replace an invalid block of the identified superblock with the valid block identified at step 320.

At 330, the memory system may determine whether the slots of the slot table include a second superblock with at least one valid block in at least one of the one or more identified planes. In some cases, the memory system may determine that the slot includes the second superblock, and the process flow 300 may continue to step 335. In other cases, the memory system may determine that the slots do not include the second superblock, and the process flow 300 may continue to step 355.

At 335, the memory system may replace an invalid block of the identified superblock with a valid block from the second superblock based on the valid block being associated with one of the identified planes.

At 340, the memory system may determine whether the second superblock includes an additional block in at least one of the one or more identified planes. In some cases, the memory system may determine that the second superblock includes an additional block in one of the identified planes, and the process flow 300 may continue to step 335. In other cases, the memory system may determine that the second superblock does not include an additional block in one of the identified planes, and the process flow 300 may continue to step 345.

At 345, the memory system may assign the second superblock to a respective slot based on a quantity of invalid blocks in the second superblock after performing the replacement at step 335. In some cases, the memory system may assign the identified superblock to a respective slot based on a quantity of invalid blocks in the identified superblock after performing the block replacement at step 325 or step 335.

At 350, the memory system may determine whether each invalid block in the identified superblock has been replaced. In some cases, the memory system may determine that the identified superblock includes two of more invalid blocks, and the process flow 300 may continue back to step 315. In other cases, the memory system may determine that the identified superblock includes one or fewer invalid blocks, and the process flow 300 may continue to step 355.

At 355, the memory system may assign the identified superblock to a respective slot. For example, if the identified superblock includes two or more invalid blocks after step 330 or step 350, the memory system may assign the identified superblock to the respective slot. In other cases, the memory system may determine that the identified superblock includes one invalid block, and the memory system may record the identified superblock as an incomplete superblock and assign the incomplete superblock to slot 1 (e.g., slot 210-b).

Similarly, the memory system may determine the identified superblock includes no invalid blocks, and the memory system may record the identified superblock as an complete superblock and assign the complete superblock to slot 0 (e.g., slot 210-a). In some examples, the memory system may assign the incomplete superblock to an incomplete superblock pool (e.g., for use in modified access operations), or the memory system may assign the complete superblock to a complete superblock pool (e.g., for use in traditional access operations). In some implementations, the process flow 300 may continue back to step 310 after assigning the identified superblock to the respective slot. Such methods may reduce overprovisioning associated with the memory system, which may reduce its overall size. Moreover, accessing incomplete superblocks may increase or otherwise prolong the usable storage capacity of the memory system.

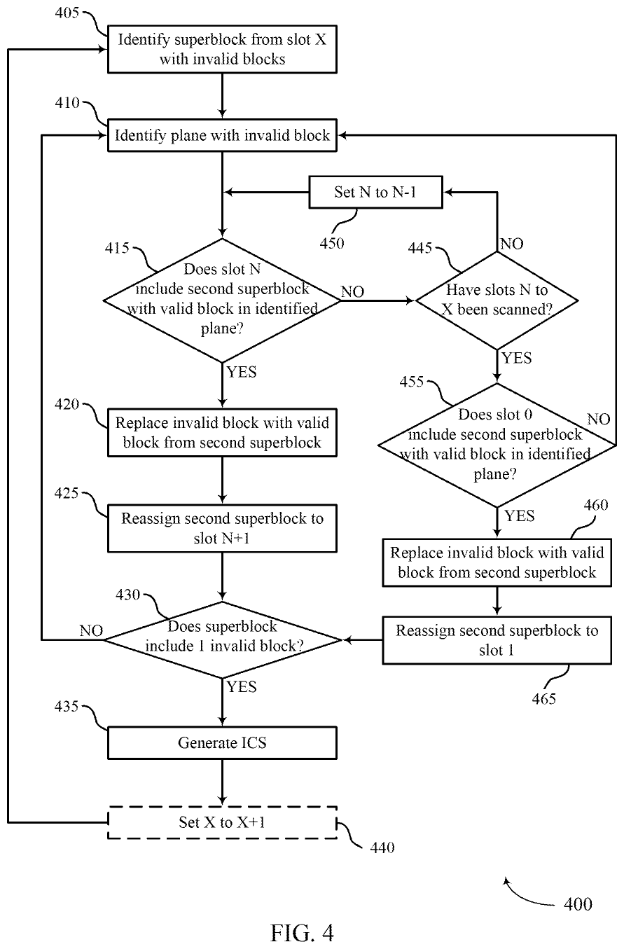

FIG. 4 illustrates an example of a process flow 400 that supports complete and incomplete superblock generation in accordance with examples as disclosed herein. The process flow 400 may illustrate aspects or operations of a system 100 and a block diagram 200, as described with reference to FIGS. 1 and 2, respectively. For example, the process flow 400 may depict operations for generating incomplete superblocks, which may be examples of a superblock 215-c-2. Such methods may reduce overprovisioning associated with the memory system, which may reduce its overall size. Moreover, accessing incomplete superblocks may increase or otherwise prolong the usable storage capacity of the memory system.

In the following description of the process flow 400, the methods, techniques, processes, and operations may be performed in different orders or at different times. Further, certain operations may be left out of the process flow 400, or other operations may be added to the process flow 400. The process flow 400 illustrates operations for replacing invalid blocks of a superblock using incomplete superblock generation techniques as described with reference to FIG. 2.

At 405, the memory system may identify a superblock with two or more invalid blocks and a corresponding slot X (e.g., where X is indicative of a quantity of invalid blocks in the superblock) associated with the superblock. For example, the memory system may identify the superblock from slot 2 (e.g., X=2) based on identifying two invalid blocks. In some cases, the memory system may identify the superblock based on determining the quantity of incomplete superblocks does not satisfy a threshold (e.g., a threshold associated with desired performance of the memory system). In some cases, the memory system may identify the superblock based on scanning the memory system, where the scanning may be initiated based on conditions of the memory system (e.g., powering on, loading firmware).

At 410, the memory system may identify a plane associated with an invalid block of the two or more invalid blocks. In some cases, the memory system may identify the plane based on determining (e.g., based on scanning the superblocks of the memory system) that the superblocks of the memory system do not include valid blocks in another plane associated with another invalid block of the two or more invalid blocks. For example, a superblock may include an invalid block in a first plane and an invalid block in a second plane, and the memory system may determine there are no valid blocks in the second plane of the superblocks. In some such examples, the memory system may select (e.g., designate) the first plane as the identified plane (e.g., the “bad” plane, the invalid plane). In other cases, the memory system may determine that the superblocks of the memory system do not include valid blocks in the two or more planes associated with the two or more invalid blocks and the process flow 400 may proceed to step 455.

At 415, the memory system may determine whether a slot N (e.g., where Nis indicative of a quantity of invalid blocks in the superblock) includes a second superblock with a valid block in the identified plane. In some cases, the slot N may be a slot associated with a greatest quantity of invalid blocks in the superblock (e.g., 15 invalid blocks, 1 valid block). In some cases, the memory system may determine that the slot N includes the second superblock, and the process flow 400 may continue to step 420. In other cases, the memory system may determine that the slot does not include the second superblock, and the process flow 400 may continue to step 445.

At 420, the memory system may replace the invalid block from the superblock with the valid block from the second superblock based on determining that the second superblock includes the valid block in the identified plane associated with the invalid block.

At 425, the memory system may reassign the second superblock to the respective slot. For example, the memory system may reassign the second superblock to a slot N+1, which may be associated with a greater quantity of invalid blocks than the previously assigned slot. In some cases, after replacing the valid block in the second superblock, the second superblock may not include valid blocks and the memory system may assign the second superblock to a discard pool. In some cases, the memory system may reassign the superblock to slot X−1 after replacing the invalid block.

At 430, the memory system may determine whether the superblock includes 1 invalid block (e.g., based on performing the block replacement at step 420 or step 460). In some cases, the memory system may determine that the superblock includes more than 1 invalid block, and the process flow 400 may continue back to step 410. In some such cases, at step 410, the memory system may identify another plane (e.g., a different plane) associated with another invalid block (e.g., a different invalid block, a second invalid block) of the two or more invalid blocks. In other cases, the memory system may determine that the superblock includes 1 invalid block, and the process flow 400 may continue to step 435.

At 435, the memory system may generate an incomplete superblock from the superblock. In some cases, generating the incomplete superblock may include recording (e.g., designating) the superblock as an incomplete superblock in an incomplete superblock pool (e.g., for selection for use in modified access operations). In some cases, the superblock may be reassigned to slot 1.

At 440, the memory system may increase the value of X to X+1. For example, at 405, the value of X may have been set to 2 and, at 440, the value of X may be set to 3. In some cases, the memory system may increase the value of X based on determining that the quantity of superblocks in slot 1 satisfies a threshold or based on determining that the slot X does not include any superblocks that may be generated into incomplete superblocks (e.g., based on scanning the superblocks of the memory system).

In some such cases, the memory system may not increase the value of X based on determining that the quantity of superblocks in slot 1 does not satisfy the threshold. After (e.g., after completing or electing not to complete) step 545, the process flow 400 may return to step 405 to perform the process of generating an incomplete superblock using another superblock from the slot X or a slot X+1.

At 445, the memory system may determine whether each slot from slot N to slot X (e.g., or to slot 2) has been scanned, based on determining that slot N does not include a second superblock with a valid block in the identified plane. In some cases, the memory system may determine that each slot from slot N to slot X has not been scanned, and the process flow 400 may continue to step 450. In other cases, the memory system may determine that each slot from slot N to X has been scanned, and the process flow 400 may continue to step 455.

At 450, the value of N may be decreased to N−1. The process flow 400 may continue at step 415 after decreasing the value of N. Therefore, after returning to step 415, slot N may be slot N−1. For example, a first iteration of slot N may have been slot 15 (e.g., each superblock including 15 invalid blocks), and after returning to step 415 from step 450, a second iteration of slot N may be slot 14 (e.g., each superblock including 14 invalid blocks).

At 455, the memory system may determine whether slot 0 (e.g., each superblock does not include an invalid block, complete superblocks) includes a second superblock (e.g., a complete superblock). In some cases, the memory system may determine that slot 0 does not include a second superblock (e.g., slot 0 is empty), and the process flow 400 may continue at step 410.

In some such cases, at step 410, the memory system may identify another plane (e.g., a different plane) associated with another invalid block (e.g., a different invalid block) of the two or more invalid blocks. In other cases, the memory system may determine that slot 0 includes a second superblock, and the process flow 400 may continue to step 460. In some examples, it may be beneficial (e.g., based on performance considerations) to generate a quantity of incomplete superblocks rather than maintain a quantity of complete superblocks (e.g., generate 2 incomplete superblocks rather than maintain one complete superblock). In some examples, the memory system may determine whether a slot from slot X−1 to slot 0 includes a second superblock with a valid block in the identified plane.

At 460, the memory system may replace the invalid block from the superblock with a valid block from the second superblock based on identifying the valid block from the identified plane associated with the invalid block.

At 465, the memory system may reassign the second superblock to slot 1 based on replacing the valid block from the second superblock with an invalid block. For example, if the second superblock was associated with slot 0, after replacement the second superblock may include 1 invalid block and may be reassigned to slot 1. In some cases (e.g., if the second superblock is associated with a slot from slot X−1 to slot 0), the second superblock may be assigned to a respective slot (e.g., associated with a respectively increased value). After reassigning the second superblock, the process flow 400 may continue to step 430. Such methods may reduce overprovisioning associated with the memory system, which may reduce its overall size. Moreover, accessing incomplete superblocks may increase or otherwise prolong the usable storage capacity of the memory system.

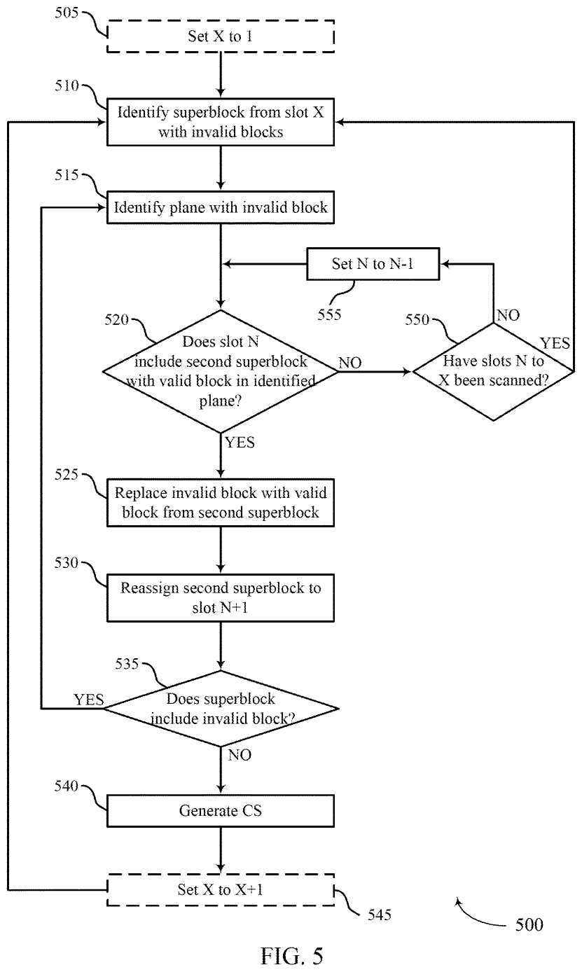

FIG. 5 illustrates an example of a process flow 500 that supports complete and incomplete superblock generation in accordance with examples as disclosed herein. The process flow 300 may illustrate aspects or operations of a system 100 and a block diagram 200, as described with reference to FIGS. 1 and 2, respectively. For example, the process flow 300 may depict operations for generating complete superblocks and incomplete superblocks, which may be examples of a superblock 215-a-2 and a superblock 215-c-2, respectively. Such methods may reduce overprovisioning associated with the memory system, which may reduce its overall size. Moreover, accessing incomplete superblocks may increase or otherwise prolong the usable storage capacity of the memory system.

In the following description of the process flow 300, the methods, techniques, processes, and operations may be performed in different orders or at different times. Further, certain operations may be left out of the process flow 300, or other operations may be added to the process flow 300. The process flow 300 illustrates operations for replacing invalid blocks of a memory system using a replacement pool or using complete and incomplete superblock generation techniques as described with reference to FIG. 2.

At 510, the memory system may identify a superblock with one or more invalid blocks from a slot X (e.g., where X is indicative of a quantity of invalid blocks in the superblock). For example, at 505, the value of X may be set to 1, such that the superblock may be selected from slot 1. In some such examples, the superblock may include 1 invalid block. In some cases, the memory system may identify the superblock based on scanning the memory system, where the scanning may be initiated based on conditions of the memory system (e.g., powering on, loading firmware).

At 515, the memory system may identify a plane associated with an invalid block of the one or more invalid blocks of the superblock.

At 520, the memory system may determine whether a slot N (e.g., where Nis indicative of a quantity of invalid blocks in the superblock) includes a second superblock with a valid block in the identified plane. In some cases, the slot N may be a slot associated with a greatest quantity of invalid blocks in the superblock (e.g., 15 invalid blocks, 1 valid block). In some cases, the memory system may determine that the slot N includes the second superblock, and the process flow 500 may continue to step 525. In other cases, the memory system may determine that the slot does not include the second superblock, and the process flow 500 may continue to step 550.

At 525, the memory system may replace the invalid block from the superblock with the valid block from the second superblock based on determining that the second superblock includes the valid block in the identified plane associated with the invalid block.

At 530, the memory system may reassign the second superblock to the respective slot. For example, the memory system may reassign the second superblock to a slot N+1, which may be associated with a greater quantity of invalid blocks than the previously assigned slot. In some cases, after replacing the valid block in the second superblock, the second superblock may not include valid blocks and the memory system may assign the second superblock to a discard pool. In some cases, the memory system may reassign the superblock to slot X−1 after replacing the invalid block.

At 535, the memory system may determine whether the superblock includes an invalid block (e.g., based on performing the replacement at step 530). In some cases, the memory system may determine that the superblock includes at least one invalid block, and the process flow 500 may continue at step 515. In some such cases, at step 515, the memory system may identify another plane (e.g., a different plane) associated with another invalid block (e.g., a different invalid block) of the one or more invalid blocks. In other cases, the memory system may determine that the superblock includes no invalid blocks, and the process flow 500 may continue at step 540.

At 540, the memory system may generate an complete superblock from the superblock. In some cases, generating the complete superblock may include recording (e.g., designating) the superblock as an complete superblock in a complete superblock pool (e.g., for selection for use in traditional access operations). In some cases, the superblock may be reassigned to slot 0.

At 545, the memory system may increase the value of X to X+1. For example, at 505, the value of X may have been set to 1, and at 545, the value of X may be set to 2. In some cases, the memory system may increase the value of X based on determining that the quantity of superblocks in slot 0, 1, or X satisfies a threshold. Accordingly, in some cases, the memory system may not increase the value of X based on determining that the quantity of superblocks in 0, 1, or X does not satisfy the threshold. After (e.g., completing or electing not to complete) step 545, the process flow 500, may continue at step 510 to perform the process of generating a complete superblock on another superblock from the slot X or a slot X+1.

At 550, the memory system may determine whether each slot from slot N to slot X has been scanned, based on determining that slot N does not include a second superblock with a valid block in the identified plane. In some cases, the memory system may determine that each slot from slot N to slot X has not been scanned, and the process flow 400 may continue to step 555. In other cases, the memory system may determine that each slot from slot N to X has been scanned, and the process flow 500 may continue to step 510. In some such cases, at step 510, the memory system may identify another superblock (e.g., a different superblock) associated with the slot X or another slot (e.g., slot X+1) with one or more invalid blocks. Additionally, or alternatively, at step 510, the memory system may identify another plane (e.g., a different plane) associated with another invalid block (e.g., a different invalid block) of the one or more invalid blocks.

At 555, the value of N may be decreased to N−1. The process flow 500 may continue back to step 520 after decreasing the value of N. Therefore, after returning to step 520, slot N may be slot N−1. For example, a first iteration of slot N may have been slot 15 (e.g., each superblock including 15 invalid blocks), and after returning to step 520 from step 555, a second iteration of slot N may be slot 14 (e.g., each superblock including 14 invalid blocks). Such methods may reduce overprovisioning associated with the memory system, which may reduce its overall size. Moreover, accessing incomplete superblocks may increase or otherwise prolong the usable storage capacity of the memory system.

FIG. 6 illustrates a block diagram 600 of a memory system 620 that supports complete and incomplete superblock generation in accordance with examples as disclosed herein. The memory system 620 may be an example of aspects of a memory system as described with reference to FIGS. 1 through 5. The memory system 620, or various components thereof, may be an example of means for performing various aspects of complete and incomplete superblock generation as described herein. For example, the memory system 620 may include a determination component 625, a replacement component 630, an access component 635, a mapping component 640, a reception component 645, a scan component 650, an assignment component 655, or any combination thereof. Each of these components may communicate, directly or indirectly, with one another (e.g., via one or more buses).

The determination component 625 may be configured as or otherwise support a means for determining whether a first superblock includes a first physical block of a first type and a second physical block of a first type, where the first superblock includes a plurality of physical blocks that are each associated with a respective plane of a memory device. In some examples, the determination component 625 may be configured as or otherwise support a means for determining whether a second superblock includes a third physical block of a second type based at least in part on determining that the first superblock includes the first physical block of the first type and the second physical block of the first type. The replacement component 630 may be configured as or otherwise support a means for replacing the first physical block with the third physical block based at least in part on determining that the second superblock includes the third physical block of the second type. The access component 635 may be configured as or otherwise support a means for accessing one or more physical blocks associated with the first superblock based at least in part on replacing the first physical block with the third physical block.

In some examples, the determination component 625 may be configured as or otherwise support a means for determining that a third superblock includes a fourth physical block of the first type before determining that the first superblock includes the first physical block and the second physical block of the first type. In some examples, the determination component 625 may be configured as or otherwise support a means for determining that a fourth superblock includes a fifth physical block of the second type based at least in part on determining that the third superblock includes the fourth physical block of the first type. In some examples, the replacement component 630 may be configured as or otherwise support a means for replacing the fourth physical block with the fifth physical block based at least in part on determining that the fourth superblock includes the fifth physical block of the second type.

In some examples, the first superblock includes an incomplete superblock based at least in part on replacing the first physical block with the third physical block. In some examples, the third superblock includes a complete superblock based at least in part on replacing the fourth physical block with the fifth physical block.

In some examples, the determination component 625 may be configured as or otherwise support a means for determining that the first physical block and the third physical block are associated with a same plane of the memory device. In some examples, the replacement component 630 may be configured as or otherwise support a means for replacing the first physical block with the third physical block based at least in part on determining that the first physical block and the third physical block are associated with the same plane of the memory device.

In some examples, the determination component 625 may be configured as or otherwise support a means for determining that a plurality of superblocks associated with the memory device do not include a physical block of the second type associated with a same plane as the second physical block based at least in part on replacing the first physical block with the third physical block. In some examples, the replacement component 630 may be configured as or otherwise support a means for refraining from replacing the second physical block based at least in part on determining that the plurality of superblocks associated with the memory device do not include a physical block of the second type associated with a same plane as the second physical block.

In some examples, the determination component 625 may be configured as or otherwise support a means for designating a first plane as a plane of the first type based at least in part on replacing the first physical block with the third physical block, where the second physical block is associated with the first plane. In some examples, the replacement component 630 may be configured as or otherwise support a means for refraining from replacing the second physical block based at least in part on designating the first plane as a plane of the first type.

In some examples, to support replacing the first physical block with the third physical block, the mapping component 640 may be configured as or otherwise support a means for updating a mapping between the first physical block with a physical block address associated with the third physical block.

In some examples, the reception component 645 may be configured as or otherwise support a means for receiving an access command associated with the first physical block based at least in part on replacing the first physical block with the third physical block, the access command including a first virtual address. In some examples, the determination component 625 may be configured as or otherwise support a means for determining whether the first virtual address satisfies a threshold value based at least in part on receiving the access command.

In some examples, the access component 635 may be configured as or otherwise support a means for accessing a first physical block address of the memory device based at least in part on determining that the first virtual address satisfies the threshold value.

In some examples, the access component 635 may be configured as or otherwise support a means for accessing a second physical block address of the memory device based at least in part on determining that the first virtual address does not satisfy the threshold value.

In some examples, physical blocks of the first type include invalid physical blocks and physical blocks of the second type include valid physical blocks.

In some examples, the first superblock includes a plurality of physical blocks of the second type and the second superblock includes a plurality of physical blocks of the first type.

In some examples, the determination component 625 may be configured as or otherwise support a means for determining that a fifth superblock includes a sixth physical block, a seventh physical block, and an eighth physical block of the first type based at least in part on replacing the first physical block with the third physical block. In some examples, the determination component 625 may be configured as or otherwise support a means for determining that a sixth superblock includes at least a ninth physical block of the second type based at least in part on determining that the fifth superblock includes the sixth physical block, the seventh physical block, and the eighth physical block of the first type. In some examples, the replacement component 630 may be configured as or otherwise support a means for replacing the eighth physical block with the ninth physical block based at least in part on determining that the sixth superblock includes the ninth physical block of the second type.

In some examples, the determination component 625 may be configured as or otherwise support a means for determining that a seventh superblock includes at least a tenth physical block of the second type based at least in part on replacing the eighth physical block with the ninth physical block. In some examples, the replacement component 630 may be configured as or otherwise support a means for replacing the seventh physical block with the tenth physical block based at least in part on determining that the seventh superblock includes the tenth physical block of the second type, where the fifth superblock includes an incomplete superblock based at least in part on replacing the seventh physical block with the tenth physical block.

In some examples, the scan component 650 may be configured as or otherwise support a means for scanning a plurality of superblocks associated with the memory device to identify physical blocks of the first type and of the second type, where determining that the first superblock includes the first physical block and the second physical block of the first type is based at least in part on scanning the plurality of superblocks.

In some examples, the assignment component 655 may be configured as or otherwise support a means for assigning each superblock of the plurality of superblocks to one or more slots associated with the memory device based at least in part on scanning the plurality of superblocks, where each slot of the one or more slots is associated with superblocks having a respective quantity of physical blocks of the first type.

FIG. 7 illustrates a flowchart showing a method 700 that supports complete and incomplete superblock generation in accordance with examples as disclosed herein. The operations of method 700 may be implemented by a memory system or its components as described herein. For example, the operations of method 700 may be performed by a memory system as described with reference to FIGS. 1 through 6. In some examples, a memory system may execute a set of instructions to control the functional elements of the device to perform the described functions. Additionally, or alternatively, the memory system may perform aspects of the described functions using special-purpose hardware.

At 705, the method may include determining whether a first superblock includes a first physical block of a first type and a second physical block of a first type, where the first superblock includes a plurality of physical blocks that are each associated with a respective plane of a memory device. The operations of 705 may be performed in accordance with examples as disclosed herein. In some examples, aspects of the operations of 705 may be performed by a determination component 625 as described with reference to FIG. 6.

At 710, the method may include determining whether a second superblock includes a third physical block of a second type based at least in part on determining that the first superblock includes the first physical block of the first type and the second physical block of the first type. The operations of 710 may be performed in accordance with examples as disclosed herein. In some examples, aspects of the operations of 710 may be performed by a determination component 625 as described with reference to FIG. 6.

At 715, the method may include replacing the first physical block with the third physical block based at least in part on determining that the second superblock includes the third physical block of the second type. The operations of 715 may be performed in accordance with examples as disclosed herein. In some examples, aspects of the operations of 715 may be performed by a replacement component 630 as described with reference to FIG. 6.

At 720, the method may include accessing one or more physical blocks associated with the first superblock based at least in part on replacing the first physical block with the third physical block. The operations of 720 may be performed in accordance with examples as disclosed herein. In some examples, aspects of the operations of 720 may be performed by an access component 635 as described with reference to FIG. 6.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for determining whether a first superblock includes a first physical block of a first type and a second physical block of a first type, where the first superblock includes a plurality of physical blocks that are each associated with a respective plane of a memory device; determining whether a second superblock includes a third physical block of a second type based at least in part on determining that the first superblock includes the first physical block of the first type and the second physical block of the first type; replacing the first physical block with the third physical block based at least in part on determining that the second superblock includes the third physical block of the second type; and accessing one or more physical blocks associated with the first superblock based at least in part on replacing the first physical block with the third physical block.

Aspect 2: The method, apparatus, or non-transitory computer-readable medium of aspect 1, further including operations, features, circuitry, logic, means, or instructions, or any combination thereof for determining that a third superblock includes a fourth physical block of the first type before determining that the first superblock includes the first physical block and the second physical block of the first type; determining that a fourth superblock includes a fifth physical block of the second type based at least in part on determining that the third superblock includes the fourth physical block of the first type; and replacing the fourth physical block with the fifth physical block based at least in part on determining that the fourth superblock includes the fifth physical block of the second type.

Aspect 3: The method, apparatus, or non-transitory computer-readable medium of aspect 2, where the first superblock includes an incomplete superblock based at least in part on replacing the first physical block with the third physical block and the third superblock includes a complete superblock based at least in part on replacing the fourth physical block with the fifth physical block.

Aspect 4: The method, apparatus, or non-transitory computer-readable medium of any of aspects 1 through 3, further including operations, features, circuitry, logic, means, or instructions, or any combination thereof for determining that the first physical block and the third physical block are associated with a same plane of the memory device and replacing the first physical block with the third physical block based at least in part on determining that the first physical block and the third physical block are associated with the same plane of the memory device.

Aspect 5: The method, apparatus, or non-transitory computer-readable medium of aspect 4, further including operations, features, circuitry, logic, means, or instructions, or any combination thereof for determining that a plurality of superblocks associated with the memory device do not include a physical block of the second type associated with a same plane as the second physical block based at least in part on replacing the first physical block with the third physical block and refraining from replacing the second physical block based at least in part on determining that the plurality of superblocks associated with the memory device do not include a physical block of the second type associated with a same plane as the second physical block.

Aspect 6: The method, apparatus, or non-transitory computer-readable medium of aspect 4, further including operations, features, circuitry, logic, means, or instructions, or any combination thereof for designating a first plane as a plane of the first type based at least in part on replacing the first physical block with the third physical block, where the second physical block is associated with the first plane and refraining from replacing the second physical block based at least in part on designating the first plane as a plane of the first type.

Aspect 7: The method, apparatus, or non-transitory computer-readable medium of any of aspects 1 through 5, where replacing the first physical block with the third physical block includes operations, features, circuitry, logic, means, or instructions, or any combination thereof for updating a mapping between the first physical block with a physical block address associated with the third physical block.

Aspect 8: The method, apparatus, or non-transitory computer-readable medium of any of aspects 1 through 7, further including operations, features, circuitry, logic, means, or instructions, or any combination thereof for receiving an access command associated with the first physical block based at least in part on replacing the first physical block with the third physical block, the access command including a first virtual address and determining whether the first virtual address satisfies a threshold value based at least in part on receiving the access command.

Aspect 9: The method, apparatus, or non-transitory computer-readable medium of aspect 8, further including operations, features, circuitry, logic, means, or instructions, or any combination thereof for accessing a first physical block address of the memory device based at least in part on determining that the first virtual address satisfies the threshold value.

Aspect 10: The method, apparatus, or non-transitory computer-readable medium of any of aspects 8 through 9, further including operations, features, circuitry, logic, means, or instructions, or any combination thereof for accessing a second physical block address of the memory device based at least in part on determining that the first virtual address does not satisfy the threshold value.

Aspect 11: The method, apparatus, or non-transitory computer-readable medium of any of aspects 1 through 10, where physical blocks of the first type include invalid physical blocks and physical blocks of the second type include valid physical blocks.

Aspect 12: The method, apparatus, or non-transitory computer-readable medium of any of aspects 1 through 11, where the first superblock includes a plurality of physical blocks of the second type and the second superblock includes a plurality of physical blocks of the first type.

Aspect 13: The method, apparatus, or non-transitory computer-readable medium of any of aspects 1 through 12, further including operations, features, circuitry, logic, means, or instructions, or any combination thereof for determining that a fifth superblock includes a sixth physical block, a seventh physical block, and an eighth physical block of the first type based at least in part on replacing the first physical block with the third physical block; determining that a sixth superblock includes at least a ninth physical block of the second type based at least in part on determining that the fifth superblock includes the sixth physical block, the seventh physical block, and the eighth physical block of the first type; and replacing the eighth physical block with the ninth physical block based at least in part on determining that the sixth superblock includes the ninth physical block of the second type.

Aspect 14: The method, apparatus, or non-transitory computer-readable medium of aspect 13, further including operations, features, circuitry, logic, means, or instructions, or any combination thereof for determining that a seventh superblock includes at least a tenth physical block of the second type based at least in part on replacing the eighth physical block with the ninth physical block and replacing the seventh physical block with the tenth physical block based at least in part on determining that the seventh superblock includes the tenth physical block of the second type, where the fifth superblock includes an incomplete superblock based at least in part on replacing the seventh physical block with the tenth physical block.

Aspect 15: The method, apparatus, or non-transitory computer-readable medium of any of aspects 1 through 14, further including operations, features, circuitry, logic, means, or instructions, or any combination thereof for scanning a plurality of superblocks associated with the memory device to identify physical blocks of the first type and of the second type, where determining that the first superblock includes the first physical block and the second physical block of the first type is based at least in part on scanning the plurality of superblocks.

Aspect 16: The method, apparatus, or non-transitory computer-readable medium of aspect 15, further including operations, features, circuitry, logic, means, or instructions, or any combination thereof for assigning each superblock of the plurality of superblocks to one or more slots associated with the memory device based at least in part on scanning the plurality of superblocks, where each slot of the one or more slots is associated with superblocks having a respective quantity of physical blocks of the first type.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,”based “on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a memory device comprising a plurality of superblocks; and
a controller coupled with the memory device and configured to cause the apparatus to:
determine whether a first superblock comprises a first physical block of a first type and a second physical block of a first type, wherein the first superblock comprises a plurality of physical blocks that are each associated with a respective plane of the memory device;
determine whether a second superblock comprises a third physical block of a second type based at least in part on determining that the first superblock comprises the first physical block of the first type and the second physical block of the first type;
replace the first physical block with the third physical block based at least in part on determining that the second superblock comprises the third physical block of the second type; and
access one or more physical blocks associated with the first superblock based at least in part on replacing the first physical block with the third physical block.

2. The apparatus of claim 1, wherein the controller is further configured to cause the apparatus to:
determine that a third superblock comprises a fourth physical block of the first type before determining that the first superblock comprises the first physical block and the second physical block of the first type;
determine that a fourth superblock comprises a fifth physical block of the second type based at least in part on determining that the third superblock comprises the fourth physical block of the first type; and
replace the fourth physical block with the fifth physical block based at least in part on determining that the fourth superblock comprises the fifth physical block of the second type.

3. The apparatus of claim 2, wherein:
the first superblock comprises an incomplete superblock based at least in part on replacing the first physical block with the third physical block; and
the third superblock comprises a complete superblock based at least in part on replacing the fourth physical block with the fifth physical block.

4. The apparatus of claim 1, wherein the controller is further configured to cause the apparatus to:
determine that the first physical block and the third physical block are associated with a same plane of the memory device; and
replace the first physical block with the third physical block based at least in part on determining that the first physical block and the third physical block are associated with the same plane of the memory device.

5. The apparatus of claim 4, wherein the controller is further configured to cause the apparatus to:
determine that a plurality of superblocks associated with the memory device do not include a physical block of the second type associated with a same plane as the second physical block based at least in part on replacing the first physical block with the third physical block; and
refrain from replacing the second physical block based at least in part on determining that the plurality of superblocks associated with the memory device do not include a physical block of the second type associated with a same plane as the second physical block.

6. The apparatus of claim 4, wherein the controller is further configured to cause the apparatus to:
designating a first plane as a plane of the first type based at least in part on replacing the first physical block with the third physical block, wherein the second physical block is associated with the first plane; and
refraining from replacing the second physical block based at least in part on designating the first plane as a plane of the first type.

7. The apparatus of claim 1, wherein replacing the first physical block with the third physical block is configured to cause the apparatus to:
update a mapping between the first physical block with a physical block address associated with the third physical block.

8. The apparatus of claim 1, wherein the controller is further configured to cause the apparatus to:
receive an access command associated with the first physical block based at least in part on replacing the first physical block with the third physical block, the access command comprising a first virtual address; and
determine whether the first virtual address satisfies a threshold value based at least in part on receiving the access command.

9. The apparatus of claim 8, wherein the controller is further configured to cause the apparatus to:
access a first physical block address of the memory device based at least in part on determining that the first virtual address satisfies the threshold value.

10. The apparatus of claim 8, wherein the controller is further configured to cause the apparatus to:
access a second physical block address of the memory device based at least in part on determining that the first virtual address does not satisfy the threshold value.

11. The apparatus of claim 1, wherein:
physical blocks of the first type comprise invalid physical blocks and physical blocks of the second type comprise valid physical blocks.

12. The apparatus of claim 1, wherein the first superblock comprises a plurality of physical blocks of the second type and the second superblock comprises a plurality of physical blocks of the first type.

13. The apparatus of claim 1, wherein the controller is further configured to cause the apparatus to:
determine that a fifth superblock comprises a sixth physical block, a seventh physical block, and an eighth physical block of the first type based at least in part on replacing the first physical block with the third physical block;
determine that a sixth superblock comprises at least a ninth physical block of the second type based at least in part on determining that the fifth superblock comprises the sixth physical block, the seventh physical block, and the eighth physical block of the first type; and
replace the eighth physical block with the ninth physical block based at least in part on determining that the sixth superblock comprises the ninth physical block of the second type.

14. The apparatus of claim 13, wherein the controller is further configured to cause the apparatus to:
determine that a seventh superblock comprises at least a tenth physical block of the second type based at least in part on replacing the eighth physical block with the ninth physical block; and
replace the seventh physical block with the tenth physical block based at least in part on determining that the seventh superblock comprises the tenth physical block of the second type, wherein the fifth superblock comprises an incomplete superblock based at least in part on replacing the seventh physical block with the tenth physical block.

15. The apparatus of claim 1, wherein the controller is further configured to cause the apparatus to:
scan a plurality of superblocks associated with the memory device to identify physical blocks of the first type and of the second type, wherein determining that the first superblock comprises the first physical block and the second physical block of the first type is based at least in part on scanning the plurality of superblocks.

16. The apparatus of claim 15, wherein the controller is further configured to cause the apparatus to:
assign each superblock of the plurality of superblocks to one or more slots associated with the memory device based at least in part on scanning the plurality of superblocks, wherein each slot of the one or more slots is associated with superblocks having a respective quantity of physical blocks of the first type.

17. A non-transitory computer-readable medium storing code comprising instructions which, when executed by a processor of an electronic device, cause the electronic device to:
determine whether a first superblock comprises a first physical block of a first type and a second physical block of a first type, wherein the first superblock comprises a plurality of physical blocks that are each associated with a respective plane of a memory device;
determine whether a second superblock comprises a third physical block of a second type based at least in part on determining that the first superblock comprises the first physical block of the first type and the second physical block of the first type;
replace the first physical block with the third physical block based at least in part on determining that the second superblock comprises the third physical block of the second type; and
access one or more physical blocks associated with the first superblock based at least in part on replacing the first physical block with the third physical block.

18. The non-transitory computer-readable medium of claim 17, wherein the instructions, when executed by the processor of the electronic device, further cause the electronic device to:
determine that a third superblock comprises a fourth physical block of the first type before determining that the first superblock comprises the first physical block and the second physical block of the first type;
determine that a fourth superblock comprises a fifth physical block of the second type based at least in part on determining that the third superblock comprises the fourth physical block of the first type; and
replace the fourth physical block with the fifth physical block based at least in part on determining that the fourth superblock comprises the fifth physical block of the second type.

19. The non-transitory computer-readable medium of claim 18, wherein:
the first superblock comprises an incomplete superblock based at least in part on replacing the first physical block with the third physical block; and
the third superblock comprises a complete superblock based at least in part on replacing the fourth physical block with the fifth physical block.

20. A method, comprising:
determining whether a first superblock comprises a first physical block of a first type and a second physical block of a first type, wherein the first superblock comprises a plurality of physical blocks that are each associated with a respective plane of a memory device;
determining whether a second superblock comprises a third physical block of a second type based at least in part on determining that the first superblock comprises the first physical block of the first type and the second physical block of the first type;
replacing the first physical block with the third physical block based at least in part on determining that the second superblock comprises the third physical block of the second type; and
accessing one or more physical blocks associated with the first superblock based at least in part on replacing the first physical block with the third physical block.
